(19) United States
(12) Patent Application Publication
(10) Pub. No.: US 2023/0331913 A1
(43) Pub. Date: Oct. 19, 2023

(54) LOW DENSITY POLYETHER BLOCK AMIDE AND HOLLOW GLASS REINFORCEMENT COMPOSITIONS AND USE OF SAME

(71) Applicant: ARKEMA FRANCE, Colombes (FR)

(72) Inventors: Guillaume VINCENT, Changshu, Jiangsu (CN); Mathieu SABARD, Serquigny (FR); Yu SUN, Changshu, Jiangsu (CN)

(73) Assignee: ARKEMA FRANCE, Colombes (FR)

(21) Appl. No.: 18/006,223

(22) PCT Filed: Jul. 19, 2021
(86) PCT No.: PCT/FR2021/051344

§ 371 Date: Jan. 20, 2023

(30) Foreign Application Priority Data
Jul. 22, 2020 (FR) FR2007679

(51) Int. Cl. C08G 69/40; C08K 7/28

(52) U.S. Cl. CPC C08G 69/40; C08K 7/28; C08K 2201/003

(57) ABSTRACT

The present invention relates to a moulding composition comprising by weight: (A) 65% to 98%, in particular 65% to 95%, of at least one copolyamide with amide units (Ba1) and polyether units (Ba2), (B) 2% to 30%, in particular 5% to 30%, of hollow glass reinforcement, (C) 0 to 5%, preferably 0.1% to 2%, of at least one additive, the sum of the proportions of each constituent (A) + (B) + (C) of the composition being equal to 100%.

### TECHNICAL FIELD

The present invention relates to compositions comprising at least one polyether block amide (PEBA) and at least one hollow glass reinforcement having a low density, the use thereof for the manufacture of an article, especially by injection, in particular for electronics, sports, motor vehicles or industry.

### BACKGROUND ART

Articles for electronics, sports, motor vehicle or industrial applications must all become lighter in order to consume less energy or minimize the energy expended when used in the context of sports in particular. They must also allow the athlete to obtain the necessary sensations for controlling movements and rapidly transmitting muscle pulses.

PEBAs, or PEBA-based compositions, are often used in these applications where the liveliness, lightness, and ductility, in particular between the ambient temperature and very low temperatures (for example -30° C.) of the article comprising these compositions are of great importance.

The density of PEBAs as measured in accordance with ISO 1183-3:1999 is generally greater than or equal to 1. Nevertheless, this density may be too high for certain applications such as those as mentioned above, and especially for sport.

In addition, the combination of polyamide and hollow glass beads is also described in the literature.

Thus, international application WO 2007/058812 describes compositions comprising a thermoplastic resin and beads having a D50 of less than or equal to 25 µm. This composition does not comprise PEBA.

Pat. US9321906 describes compositions comprising a host resin chosen from a polyamide and a propylene resin and hollow glass microspheres. This composition does not comprise PEBA.

Application US20170058123 describes molding compositions with a density of less than 0.97 g/cm³, comprising an amorphous polyamide, a microcrystalline or partially semi-crystalline polyamide, hollow glass beads and impact modifiers. This composition does not comprise PEBA.

Application US 2006/189784 describes compositions comprising a polyether amide comprising a carboxylic acid polyamide and a polyetheramine, and glass particles.

Furthermore, the compositions used for the above applications must be able to be easily injected and allows parts to be obtained with an attractive appearance and an ability to be dyed in a variety of colors.

Therefore, the present invention relates to a molding composition, comprising by weight:
(A) from 65% to 98%, especially from 65% to 95%, of at least one copolyamide with amide units (Ba1) and with polyether units (Ba2),
(B) from 2% to 30%, especially from 5% to 30%, of hollow glass reinforcement,
(C) from 0% to 5%, preferably 0.1% to 2%, of at least one additive, the sum of the proportions of each constituent (A) + (B) + (C) of said composition being equal to 100%.

Unexpectedly, the inventors have found that the addition of hollow glass beads, in a specific proportion range, in PEBAs makes it possible to obtain compositions that have a low density without losing rigidity, while still maintaining good impact strength, good elongation and good injectability by way of an injection molding method.

### Regarding PEBA (A)

Polyether block amides (PEBAs) are copolymers with amide units (Ba1) and polyether units (Ba2), said amide unit (Ba1) corresponding to an aliphatic repeating unit chosen from a unit obtained from at least one amino acid or a unit obtained from at least one lactam, or a unit X.Y obtained from the polycondensation:
of at least one diamine, said diamine preferentially being chosen from a linear or branched aliphatic diamine or a mixture thereof, and
of at least one carboxylic diacid, said diacid preferentially being chosen from:
   a linear or branched aliphatic diacid, or a mixture thereof,
   said diamine and said diacid comprising 4 to 36 carbon atoms, advantageously 6 to 18 carbon atoms;
   said polyether units (Ba2) being especially derived from at least one polyalkylene ether polyol, especially a polyalkylene ether diol,
   PEBAs especially result from the copolycondensation of polyamide sequences with reactive ends with polyether sequences with reactive ends, such as, inter alia:
      1) Polyamide sequences with diamine chain ends with polyoxyalkylene sequences with dicarboxylic chain ends.
      2) Polyamide sequences with dicarboxylic chain ends with polyoxyalkylene sequences with diamine chain ends obtained by cyanoethylation and hydrogenation of alpha-omega dihydroxylated aliphatic polyoxyalkylene sequences referred to as polyalkylene ether diols (polyetherdiols). 3) Polyamide sequences with dicarboxylic chain ends with polyetherdiols, the products obtained being, in this particular case, polyether ester amides. The copolymers of the invention are advantageously of this type.

The polyamide sequences with dicarboxylic chain ends come for example from the condensation of polyamide precursors in the presence of a chain-limiting carboxylic diacid.

The polyamide sequences with diamine chain ends come for example from the condensation of polyamide precursors in the presence of a chain-limiting diamine.

The polyamide and polyether block polymers may also comprise randomly distributed units. These polymers may be prepared by the simultaneous reaction of polyether and polyamide block precursors.

For example, polyetherdiol, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Alternatively, polyetherdiamine, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Amide unit (Ba1): The amide unit (Ba1) corresponds to an aliphatic repeating unit as defined hereinbefore.

Advantageously, the amide unit (Ba1) is chosen from polyamide 11, polyamide 12, polyamide 610, polyamide 612, polyamide 1010, polyamide 1012, in particular polyamide 11.

More advantageously, the amide unit (Ba1) is chosen from polyamide 11 and polyamide 12, in particular polyamide 11.

Polyether unit (Ba2):
The polyether units are especially derived from at least one polyalkylene ether polyol, in particular they are derived from at least one polyalkylene ether polyol, in other words, the polyether units consist of at least one polyalkylene ether polyol. In this embodiment, the expression “of at least one polyalkylene ether polyol” means that the polyether units consist exclusively of alcohol chain ends and therefore cannot be a polyetherdiamine triblock type compound.

The composition of the invention therefore is free of polyetherdiamine triblock.

Advantageously, the polyether units (Ba2) are chosen from polyethylene glycol (PEG), polypropylene glycol (PPG), polytrimethylene glycol (PO3G), polytetramethylene glycol (PTMG) and the mixtures or copolymers thereof, in particular PTMG.

The number average molecular weight (Mn) of the polyether blocks is advantageously between 200 and 4000 g/mol, preferably between 250 and 2500 g/mol, especially between 300 and 1100 g/mol.

The PEBA can be prepared by the following method in which:
in a first step, the polyamide blocks (Ba1) are prepared by polycondensation of the lactam(s), or
   of the amino acid(s), or
   of the diamine(s) and of the carboxylic diacid(s); and if necessary, of the comonomer(s) chosen from the lactams and the alpha-omega aminocarboxylic acids;
   in the presence of a chain limiter chosen from the carboxylic diacids; then
in a second step, the polyamide blocks (Ba1) obtained are reacted with polyether blocks (Ba2) in the presence of a catalyst.

The general method for two-step preparation of the copolymers of the invention is known and is described, for example, in French patent FR 2 846 332 and in European patent EP 1 482 011.

The reaction for forming the block (Ba1) usually takes place between 180 and 300° C., preferably between 200 and 290° C., the pressure inside the reactor is between 5 and 30 bar, and is maintained for about 2 to 3 hours. The pressure is slowly reduced by bringing the reactor to atmospheric pressure, and then the excess water is distilled off, for example for an hour or two.

Once the polyamide with carboxylic acid ends has been prepared, the polyether and a catalyst are added. The polyether may be added in one or several stages, as can the catalyst. In an advantageous embodiment, the polyether is added first, the reaction of the OH ends of the polyether and the COOH ends of the polyamide begins with the formation of ester bonds and the removal of water. As much water as possible is removed from the reaction medium by distillation, then the catalyst is introduced to complete the bonding of the polyamide blocks and the polyether blocks. This second step is carried out under stirring, preferably under a vacuum of at least 15 mm Hg (2000 Pa) at a temperature such that the reagents and copolymers obtained are in the molten state. As an example, this temperature can be comprised between 100 and 400° C. and most commonly 200 and 300° C. The reaction is monitored by measuring the torque exerted by the molten polymer on the stirrer or by measuring the electrical power consumed by the stirrer. The end of the reaction is determined by the value of the target torque or power.

One or several molecules used as antioxidant, for example Irganox® 1010 or Irganox® 245, may also be added during the synthesis, at the moment deemed most appropriate.

The PEBA preparation process may also be considered so that all the monomers are added at the beginning, in a single step, in order to perform the polycondensation:
of the lactam(s), or
of the amino acid(s), or
of the diamine(s) and the carboxylic diacid(s); and optionally, of the other
polyamide comonomer(s);
   in the presence of a chain limiter chosen from the carboxylic diacids;
   in the presence of the blocks (Ba2) (polyether);
   in the presence of a catalyst for the reaction between the soft blocks (Ba2) and the blocks (Ba1).

Advantageously, said carboxylic diacid is used as a chain limiter, which is introduced in excess with respect to the stoichiometry of the diamine(s).

Advantageously, a derivative of a metal chosen from the group formed by titanium, zirconium and hafnium or a strong acid such as phosphoric acid, hypophosphorous acid or boric acid is used as catalyst.

The polycondensation can be carried out at a temperature of 240 to 280° C.

Generally speaking, the known copolymers with ether and amide units consist of linear and semi-crystalline aliphatic polyamide sequences (for example Arkema’s “Pebax”).

In one embodiment, the copolyamide with amide units (Ba1) and with polyether units (Ba2) has a density greater than or equal to 1, in particular greater than or equal to 1.01, especially greater than or equal to 1.02, as determined in accordance with ISO 1183-3: 1999.

In one embodiment, the polyetheramines are excluded from the polyether units (Ba2).

### Regarding Hollow Glass Reinforcement (B)

The hollow glass reinforcement corresponds to a glass reinforcement material with a hollow (as opposed to solid) structure that can have any shape as long as it is hollow.

The hollow glass reinforcer can especially be hollow glass fibers or hollow glass beads. In particular, the hollow glass reinforcement is chosen from hollow glass beads.

The short hollow glass fibers preferably have a length of between 2 and 13 mm, preferably 3 to 8 mm, before the compositions are used.

Hollow glass fibers means glass fibers in which the hollow (or hole or window or void) within the fiber is not necessarily concentric relative to the outer diameter of said fiber.

The hollow glass fiber can be:
either with a circular cross-section having an outer diameter comprised from 7 to 75 µm, preferentially from 9 to 25 µm, more preferentially from 10 to 12 µm.

It is obvious that the diameter of the hollow (the term “hollow” can also be called hole or window or void) is not equal to the outer diameter of the hollow glass fiber.

Advantageously, the diameter of the hollow (or hole or window) is from 10% to 80%, in particular from 60 to 80% of the outer diameter of the hollow fiber.
or with a non-circular cross-section having a L/D ratio (where L represents the largest dimension of the cross-section of the fiber and D the smallest dimension of the cross-section of said fiber) between 2 and 8, in particular between 2 and 4. L and D can be measured by scanning electron microscopy (SEM).

Advantageously, the hollow glass reinforcement content is from 5 to 25% by weight, preferably from 7 to 25% by weight, in particular from 10 to 25%.

In one embodiment, the hollow glass reinforcement is hollow glass beads.

The hollow glass beads are present in the composition from 2 to 30% by weight, in particular from 5 to 30% by weight.

In another embodiment, they are present from 5 to 25% by weight, in particular from 7 to 25% by weight, especially from 10 to 25% by weight.

The hollow glass beads have a compressive strength, measured according to ASTM D 3102-72 (1982) in glycerol, of at least 50 MPa and particularly preferably of at least 100 MPa.

Advantageously, the hollow glass beads have a volume mean diameter d₅₀ of 10 to 80 µm, preferably of 13 to 50 µm, measured using laser diffraction in accordance with standard ASTM B 822-17.

The hollow glass beads can be surface treated with, for example, systems based on aminosilanes, epoxysilanes, polyamides, in particular hydrosoluble polyamides, fatty acids, waxes, silanes, titanates, urethanes, polyhydroxyethers, epoxides, nickel or mixtures thereof can be used for this purpose. The hollow glass beads are preferably surface treated with aminosilanes, epoxysilanes, polyamides or mixtures thereof.

The hollow glass beads can be formed from a borosilicate glass, preferably from a calcium-borosilicate sodium-oxide carbonate glass.

The hollow glass beads preferably have a real density of 0.10 to 0.65 g/cm3, preferably from 0.20 to 0.60 g/cm3, particularly preferably from 0.30 to 0.50 g/cm3, measured according to ASTM standard D 2840-69 (1976) with a gas pycnometer and helium as the measuring gas.

Advantageously, the hollow glass beads have a compressive strength, as measured in accordance with ASTM D 3102-72 (1982) in glycerol, of at least 50 MPa, in particular of at least 100 MPa.

### Regarding the Composition

In a first variant, said molding composition comprises by weight:
(A) from 65 to 98%, especially from 65 to 95%, of at least one copolyamide with amide units (Ba1) and with polyether units (Ba2),
(B) from 2 to 30%, especially from 5 to 30% of hollow glass reinforcement,
(C) from 0 to 5%, preferably 0.1 to 2%, of at least one additive, the sum of the proportions of each constituent (A) + (B) + (C) of said composition being equal to 100%.

In one embodiment of the first variant, said molding composition consists of (by weight):
(A) from 65 to 98%, especially from 65 to 95%, of at least one copolyamide with amide units (Ba1) and with polyether units (Ba2),
(B) from 2 to 30%, especially from 5 to 30% of hollow glass reinforcement,
(C) from 0 to 5% of at least one additive, the sum of the proportions of each constituent (A) + (B) + (C) of said composition being equal to 100%.

In another embodiment of the first variant, said molding composition consists of (by weight):
(A) from 68 to 97.9%, especially from 68 to 94.9%, of at least one copolyamide with amide units (Ba1) and with polyether units (Ba2),
(B) from 2 to 30%, especially from 5 to 30% of hollow glass reinforcement,
(C) from 0.1 to 2% of at least one additive, the sum of the proportions of each constituent (A) + (B) + (C) of said composition being equal to 100%.

In a second variant, said composition comprises by weight:
(A) from 70 to 95%, especially from 70 to 93%, in particular from 70 to 90% of at least one copolyamide with amide units (Ba1) and with polyether units (Ba2),
(B) from 5 to 25%, especially from 7 to 25%, of hollow glass reinforcement, in particular from 10 to 25% of hollow glass reinforcement,
(C) from 0 to 5%, preferably from 0.1 to 2%, of at least one additive, the sum of the proportions of each constituent (A) + (B) + (C) of said composition being equal to 100%.

In one embodiment of the second variant, said molding composition consists of (by weight):
(A) from 70 to 95%, especially from 70 to 93%, in particular from 70 to 90% of at least one copolyamide with amide units (Ba1) and with polyether units (Ba2),
(B) from 5 to 25%, especially from 7 to 25%, of hollow glass reinforcement, in particular from 10 to 25% of hollow glass reinforcement,
(C) from 0 to 5% of at least one additive, the sum of the proportions of each constituent (A) + (B) + (C) of said composition being equal to 100%.

In another embodiment of the second variant, said molding composition consists of (by weight):
(A) from 73 to 94.9%, especially from 73 to 92.9%, in particular from 73 to 89.9%, of at least one copolyamide with amide units (Ba1) and with polyether units (Ba2),
(B) from 5 to 25%, especially from 7 to 25%, of hollow glass reinforcement, in particular from 10 to 25% of hollow glass reinforcement,
(C) from 0.1 to 2% of at least one additive, the sum of the proportions of each constituent (A) + (B) + (C) of said composition being equal to 100%.

Advantageously, the molding composition according to the invention has a density of less than 1, more preferably less than 0.98, as determined in accordance with ISO 1183-3: 1999.

More advantageously, the molding composition according to the invention has a density of less than 0.97, even more preferably less than 0.96, as determined in accordance with ISO 1183-3: 1999.

Advantageously, the amide unit (Ba1) corresponds to an aliphatic repeating unit as defined hereinbefore.

Advantageously, the amide unit (Ba1) of the copolyamide of the composition of the invention is chosen from polyamide 11, polyamide 12, polyamide 610, polyamide 612, polyamide 1010, polyamide 1012, in particular polyamide 11.

More advantageously, the amide unit (Ba1) of the copolyamide of the composition of the invention is chosen from polyamide 11 and polyamide 12, in particular polyamide 11.

### Regarding the Additive (C)

The additive is optional and comprised from 0 to 5%, in particular from 0.1 to 2% by weight.

The additive is chosen from fillers, dyes, stabilizers, plasticizers, surfactants, nucleating agents, pigments, brighteners, antioxidants, lubricants, flame retardants, natural waxes, impact modifiers, laser marking additives, and mixtures thereof.

As an example, the stabilizer may be a UV stabilizer, an organic stabilizer or more generally a combination of organic stabilizers, such as a phenol antioxidant (for example of the type Irganox 245 or 1098 or 1010 by Ciba-BASF), a phosphite antioxidant (for example Irgafos® 126 by Ciba-BASF) and even optionally other stabilizers like a HALS, which means hindered amine light stabilizer (for example Tinuvin 770 by Ciba-BASF), an anti-UV (for example Tinuvin 312 by Ciba), a phosphorus-based stabilizer. Amine antioxidants such as Crompton’s Naugard 445 or even polyfunctional stabilizers such as Clariant’s Nylostab S-EED may also be used.

This stabilizer may also be a mineral stabilizer, such as a copper-based stabilizer. By way of example of such mineral stabilizers, mention may be made of halides and copper acetates. Secondarily, other metals such as silver may optionally be considered, but these are known to be less effective. These copper-based compounds are typically associated with alkali metal halides, particularly potassium.

By way of example, the plasticizers are chosen from benzene sulfonamide derivatives, such as n-butyl benzene sulfonamide (BBSA); ethyl toluene sulfonamide or N-cyclohexyl toluene sulfonamide; hydroxybenzoic acid esters, such as 2-ethylhexyl parahydroxybenzoate and 2-decylhexyl parahydroxybenzoate; esters or ethers of tetrahydrofurfuryl alcohol, like oligoethyleneoxytetrahydrofurfuryl alcohol; and esters of citric acid or of hydroxy-malonic acid, such as oligoethyleneoxy malonate.

Using a mixture of plasticizers would not be outside the scope of the invention.

By way of example, the fillers can be selected from silica, graphite, expanded graphite, carbon black, kaolin, magnesia, slag, talc, wollastonite, mica, nanofillers (carbon nanotubes), pigments, metal oxides (titanium oxide), metals, advantageously wollastonite and talc, preferentially talc.

By way of example, the impact modifiers are polyolefins having a modulus < 200 MPa, in particular < 100 MPa, as measured in accordance with ISO standard 178:2010, at 23° C.

In one embodiment, the impact modifier is chosen from a functionalized or non-functionalized polyolefin having a modulus < 200 MPa, in particular < 100 MPa, and mixtures thereof.

Advantageously, the functionalized polyolefin has a function selected from the maleic anhydride, carboxylic acid, carboxylic anhydride and epoxide functions, and is in particular selected from the ethylene/octene copolymers, ethylene/butene copolymers, ethylene/propylene (EPR) elastomers, elastomeric ethylene-propylene-diene copolymers (EPDM) and ethylene/alkyl (meth)acrylate copolymers.

By way of example, the laser marking additives are: Iriotec® 8835/Iriotec® 8850 from MERCK and Laser Mark® 1001074-E/Laser Mark® 1001088-E from Ampacet Corporation.

According to another aspect, the present invention relates to the use of a composition as defined above, for the production of an article, notably for electronics, sports, motor vehicles or industry.

All the technical characteristics defined above for the composition as such are also valid for the use thereof.

In one embodiment, the article is manufactured by injection molding.

According to yet another aspect, the present invention relates to an article obtained by injection molding with a composition as defined above.

All the technical characteristics detailed above for the composition as such are valid for the article.

According to another aspect, the present invention relates to the use of 2 to 30% by weight of hollow glass reinforcement with at least one PEBA optionally comprising at least one additive, said PEBA being present from 65 to 98% by weight and said additive being comprised from 0 to 5% by weight, to make up a composition the density of which is lower than that of said PEBA used alone with optionally at least one additive, and said density of said composition being lower than 1.

All the technical characteristics defined above for the composition as such are valid for the use thereof.

### EXAMPLES

Preparation of the compositions of the invention and mechanical properties:
The compositions of tables I and II were prepared by melt blending PEBA granules with the hollow glass beads and, optionally the additives. This mixture was made by compounding on a 26 mm diameter twin-screw co-rotating extruder with a flat temperature profile (T°) at 250° C. The screw speed is 250 rpm and the flow rate is 15 kg/h.

The introduction of the hollow glass beads is carried out with a side feeder.

The one or more PEBAs and the additives are added during the compounding process in the main hopper.

The compositions were then molded on an injection molding machine (Engel) at a setpoint temperature of 220° C. and a molding temperature of 50° C. in the shape of dumbbells (see tables 3 and 4) or bars in order to study the properties of the compositions according to the standards below.

The tensile modulus was measured at 23° C. according to ISO standard 527-1: 2012 on dumbbells of type 1A.

The machine used is of the I NSTRON 5966 type. The speed of the crosshead is 1 mm/min for the modulus measurement. The test conditions are 23° C. +/- 2° C., on dry samples.

The impact strength was determined according to ISO 179-1: 2010/1eU (Charpy impact) on non-notched bars of size 80 mm × 10 mm × 4 mm, at a temperature of 23° C. +/- 2° C. at a relative humidity of 50% +/- 10% or at -30° C. +/- 2° C. at a relative humidity of 50% +/- 10% on dry samples.

The density of the injected compositions was measured in accordance with ISO standard 1183-3:1999 at a temperature of 23° C. on bars of size 80 mm × 10 mm × 4 mm.

TABLE 1

| The contents are expressed as a % by weight | CE 1 | E1 | E2 | E3 | E4 | E5 | E6 |
|---|---|---|---|---|---|---|---|
| PEBA 11/PTMG 50% PTMG, d = 1.03 | 100 | 94.70 | 89.70 | 89.70 | | 84.70 | 79.70 |
| PEBA 12/PTMG 50% PTMG, d = 1.00 | | | | | 89.70 | | |
| iM16k hollow glass beads from 3 M | - | 5.00 | | 10.00 | 10.00 | 15.00 | 20.00 |
| L20090 hollow glass beads from 3 M | | | 10.00 | | | | |
| additives | - | 0.3 | 0.3 | 0.3 | 0.3 | 0.3 | 0.3 |
| density (g/cm3) | 1.03 | 0.99 | 0.97 | 0.97 | 0.95 | 0.95 | 0.92 |
| Tensile modulus (according to ISO527:2012) in MPa | 83 | 100 | 115 | 118 | 117 | 140 | 183 |
| Non-notched Charpy impact according to ISO 179-1:2010/1eU strength (kJ/m²) at 23° C. | NB | NB | NB | NB | NB | NB | NB |
| Non-notched Charpy impact according to ISO 179-1:2010/1eU at -30° C. (kJ/m²) | NB | NB | NB | NB | NB | NB | NB |
| Elongation measured according to ISO 527-1:2019 (%) | >500 | >500 | >500 | >500 | >500 | >200 | >100 |

NB: No breakage

TABLE 2

| The contents are expressed as a % by weight | CE2 | E7 | E8 | E9 | E10 |
|---|---|---|---|---|---|
| PEBA 11/PTMG 4% PTMG, d = 1.03 | 100 | 94.7 | 89.7 | 84.7 | 79.7 |
| iM16k hollow glass beads from 3 M | - | 5.00 | 10.00 | 15.00 | 20.00 |
| additives | 0.3 | 0.3 | 0.3 | 0.3 | 0.3 |
| density (g/cm3) | 1.03 | 0.99 | 0.98 | 0.96 | 0.94 |
| Tensile modulus (according to ISO527:2012) in MPa | 827 | 884 | 1033 | 1196 | 1303 |
| Non-notched Charpy impact according to ISO 179-1:2010/1eU strength (kJ/m²) at 23° C. | NB | NB | NB | NB | NB |
| Non-notched Charpy impact according to ISO 179-1:2010/1eU at -30° C. (kJ/m²) | NB | NB | NB | NB | NB |
| Elongation measured according to ISO 527-1:2019 (%) | >300 | >50 | >30 | >30 | >30 |

NB: No breakage

The addition of hollow glass beads to the PEBA makes it possible to significantly decrease the density of the compositions relative to PEBA alone and thus to obtain compositions that are lighter in weight than just PEBA alone, without losing rigidity and while having very good impact strength and good processability (see tables 3 and 4).

The dumbbells of type 1A were obtained by injection on an Engel-type injection molding machine:

TABLE 3

| | Injection temperature (°C) from the nozzle to the hopper (setpoint value) | Injection pressure (bar) measured | Mold temperature (°C) (Setpoint value) | Cycle time (s) | Injectability and surface appearance (visual) |
|---|---|---|---|---|---|
| CE1 | 215/220/220/205 | 1046 | 50 | 100 | OK |
| E1 | | 1220 | | 130 | OK |
| E2 | | 1233 | | 80 | OK |
| E3 | | 1231 | | 80 | OK |
| E4 | | 1230 | | 80 | OK |
| E5 | | 1248 | | 55 | OK |
| E6 | | 1165 | | 60 | OK |

TABLE 4

| | Injection temperature (°C) from the nozzle to the hopper (setpoint value) | Injection pressure (bar) measured | Mold temperature (°C) (Setpoint value) | Cycle time (s) | Injectability and surface appearance (visual) |
|---|---|---|---|---|---|
| CE2 | 215/220/220/205 | 1174 | 50 | 56 | OK |
| E7 | | 1146 | | 56 | OK |
| E8 | | 1251 | | 62 | OK |
| E9 | | 1280 | | 56 | OK |
| E10 | | 1333 | | 56 | OK |

1. A molding composition, comprising by weight:
(A) from 65% to 98%of at least one copolyamide with amide units (Ba1) and with polyether units (Ba2),
(B) from 2% to 30%,of hollow glass reinforcement,
(C) from 0% to 5% of at least one additive,
the sum of the proportions of each constituent (A) + (B) + (C) of said composition being equal to 100%.

2. The composition as claimed in claim 1, wherein said amide unit (Ba1) corresponds to a repeating unit chosen from a unit obtained from at least one amino acid or a unit obtained from at least one lactam, or a unit X.Y obtained from the polycondensation of at least one diamine and at least one dicarboxylic acid.

3. The composition as claimed in claim 1, wherein the polyether units (Ba2) are chosen from polyethylene glycol (PEG), polypropylene glycol (PPG), polytrimethylene glycol (PO3G), polytetramethylene glycol (PTMG) and the mixtures or copolymers thereof.

4. The composition as claimed in claim 1, wherein the copolyamide with amide units (Ba1) and with polyether units (Ba2) has a density greater than or equal to 1, as determined in accordance with ISO 1183-3: 1999.

5. The composition as claimed in claim 1, the molding composition has a density of less than 1, as determined in accordance with ISO 1183-3: 1999.

6. The composition as claimed in claim 1, e the hollow glass reinforcement content is comprised from 5 to 25% by weight.

7. The composition as claimed in claim 1, the hollow glass reinforcement is hollow glass beads.

8. The composition as claimed in claim 7,wherein the hollow glass beads have a volume mean diameter d₅₀ of 10 to 80 µm, as measured using laser diffraction in accordance with ASTM standard B 822-17.

9. The composition as claimed in claim 7, the hollow glass beads have a real density from 0.10 to 0.65 g/cm³, measured in accordance ASTM D 2840-69 (1976) using a gas pycnometer and helium as the measuring gas.

10. The composition as claimed in claim 7, wherein the hollow glass beads have a compressive strength, as measured in accordance with ASTM D 3102-72 (1982) in glycerol, of at least 50 MPa .

11. The composition as claimed in claim 7, wherein the amide unit (Ba1) is chosen from polyamide 11, polyamide 12, polyamide 610, polyamide 612, polyamide 1010, polyamide 1012.

12. The composition as claimed in claim 1, wherein the amide unit (Ba1) is chosen from polyamide 11 and polyamide 12.

13. The composition as claimed in claim 1, wheŗein said at least one additive is chosen from fillers, dyes, stabilizers, plasticizers, surfactants, nucleating agents, pigments, whitening agents, antioxidants, lubricants, flame retardants, natural waxes, impact modifiers and mixtures thereof.

14. A method comprising the use of a composition as defined in claim 1, for the manufacture of an article.

15. The method as claimed in claim 14, wherein the article is manufactured by injection molding.

16. An article obtained by injection molding with a composition as defined in claim 1.

17. A method comprising the use of 2 to 30% by weight of hollow glass reinforcement with at least one polyether block amide (PEBA) said PEBA being present from 65 to 98% by weight and said additive being comprised from 0 to 5% by weight, to make up a composition as defined in claim 1, the density of which is less than that of said PEBA used alone with optionally at least one additive, and said density of said composition being less than 1.
